(19) United States
(12) Patent Application Publication
(10) Pub. No.: US 2018/0072410 A1
(43) Pub. Date: Mar. 15, 2018

(54) VTOL ROTOR ASSEMBLY WITH STOWABLE BLADES

(71) Applicant: Black Night Enterprises, Inc., Delta, UT (US)

(72) Inventor: Neldon P. Johnson, Delta, UT (US)

(73) Assignee: Black Night Enterprises, Inc., Delta, UT (US)

(21) Appl. No.: 15/261,811

(22) Filed: Sep. 9, 2016

(51) Int. Cl. B64C 27/473; B64C 27/72

(52) U.S. Cl. CPC B64C 27/473; B64C 27/72

(57) ABSTRACT

A VTOL rotor assembly for a compound VTOL aircraft, the VTOL rotor assembly having a rotor sleeve, a pair of rotor blades which are extendable from the rotor sleeve for vertical take off and landing and retractable to the rotor sleeve as forward air speed exceeds the stall speed for the compound VTOL aircraft, and a rotor hub for connecting the rotor sleeve to a rotor power assembly. Rotor blade motivators controlled by a rotor blade controller determine the pitch of the respective rotor blades through interaction of the pilot of the VTOL aircraft with the rotor blade controller.

### BACKGROUND OF INVENTION

This invention relates to compound vertical take-off and landing (VTOL) aircraft and in particular to VTOL rotor assemblies for compound VTOL aircraft.

The respective limitations of conventional aircraft and helicopters are well known. Conventional winged aircraft provide for a speedy and efficient forward flight but require substantial horizontal take-off and landing distances and generally require level, paved, and well maintained runways. Conversely, helicopters have VTOL capabilities and can take-off from and land in a small landing zone that may or may not be particularly flat or level and may or may not be paved or maintained as a landing site for helicopters. However, helicopters are not well adapted for efficient forward level flight. The forward velocity limit of helicopters is limited by a number of factors, including particularly retreating blade stall. As the forward velocity of a helicopter increases, the airspeed over a retreating rotor blade is decreased. Hence, the forward velocity of a helicopter is limited to a speed less than that forward speed which would induce the retreating blade stall as the helicopter moves forward.

There have been a number of attempts to overcome the take-off and landing limitations of conventional aircraft and a number of attempts to overcome the forward speed limitations of helicopters by providing VTOL capability to aircraft with a conventional aircraft fixed wing and forward thrust capability. Such aircraft are commonly referred to commonly as compound VTOL aircraft. Such attempts to combine the VTOL capabilities of helicopters and the forward speed and efficiency of conventional winged aircraft have met with varying degrees of success. One of the major problems or limitations experienced by compound VTOL aircraft is related to wind resistance and forward flight interference imposed by the VTOL rotor assembly.

It is an objective of the present invention to provide a rotor assembly for compound VTOL aircraft which reduces the wind resistance of the rotor assembly during conventional forward flight.

It is a further objective of the present invention to provide a rotor assembly for compound VTOL aircraft which provides for stowing of the VTOL rotor blades during conventional forward flight.

### SUMMARY OF INVENTION

The present invention provides a rotor assembly for a compound VTOL aircraft with extendable and retractable blades. The rotor assembly connects to and is powered by a generally vertical rotor shaft which is powered by an engine of the aircraft. A preferred embodiment of the rotor assembly of the present invention has a rotor sleeve with blade sleeves ends. The rotor sleeve has blade sleeve ends.

Each of the rotor blades may have a blade non-pitching section and a blade drive key. The first rotor blade has a first blade non-pitching section in a position proximal to a first rotor blade key which is positioned proximal to a first blade inside end. Likewise the second rotor blade has a second blade non-pitching section which is positioned proximal to a second blade key which is positioned proximal to second blade inside end. A first blade pitch joint rotatably separates the first blade non-pitching section from the first blade pitching section. A second blade pitch joint rotatably separates the second blade non-pitching section from the second blade pitching section. As the rotor blades are extended from a blade retracted configuration to a blade extended configuration, the first blade pitch joint is positioned outside the first rotor blade sleeve end and the second blade pitch joint is positioned outside the second rotor blade sleeve end, which provide for a first blade pitch and a second blade pitch.

First blade pitch may be controlled by a first blade motivator and second blade pitch may be controlled by second motor blade motivator. The first blade motivator may be connected to the first blade pitching section by a first tubular shaft and the second blade motivator may be connected to the second blade pitching section by a second tubular shaft. First blade key rotation imparted on the first rotor blade key by the first blade motivator through rotation of the first motivator driver causes the first tubular shaft to rotate, which imparts first blade pitch on the first blade pitching section of the first rotor blade. Likewise, second rotor blade key rotation imparted on second rotor blade key by second rotor blade motivator through rotation of the second motivator driver causes the second tubular shaft to rotate, which imparts second blade pitch on the second blade pitching section of the second rotor blade.

The first rotor blade shaft and the second rotor blade shaft may be tubular, but may be solid for other embodiments. The rotor blade shafts may be tubular to provide for the passage of pressurized air for use in extending the rotor blades from the blade retracted configuration to the blade extended configuration. The first rotor blade shaft and the second rotor blade shaft may be non-rotating and may extend beyond the first blade sleeve end and the second blade sleeve end respectively, when the rotor blades are in a blade retracted configuration, by approximately the distance that the first rotor blade and the second rotor blade respectively extend beyond the first blade sleeve end and the second blade sleeve end respectively, when the rotor blades are in the blade retracted configuration.

The first rotor blade may be extended through a sleeve end blade opening from the retracted configuration to the extended configuration by the first tubular shaft sliding upon first rotor blade shaft, and the second rotor blade may be extended through a sleeve end blade opening from the retracted configuration to the extended configuration by the second tubular shaft sliding upon the second rotor blade shaft. A first shaft bearing and a second shaft bearing respectively may consist merely of the slidable and rotatable contact of all or a portion of the inside surface of the respective first tubular shaft and the second tubular shaft with the outside surface of the respective first and second rotor blade shafts, which may be lubricated as needed, or may consist of one or more mechanical bearings known to persons of skill in the art, in view of the disclosures of this specification and the drawings, may be provided.

A first pass bearing may provide for the rotation of first tubular shaft in the first non rotating section, and a second pass bearing may provide for the rotation of the second tubular shaft in the second non-rotating section. Each of the tubular shafts may have a blade rib positioned in a blade rib track in the blade core for reinforcing, strengthening and stiffening of the rotor blades. The blade core, which may be comprised of a lightweight structural foam or other material known to persons of ordinary skill in the art, in view of the disclosures of this specification and the drawings, may also assist in maintaining the proper alignment and positioning of the tubular shafts in the respective rotor blades. The tubular shafts of the respective rotor blades may be slidably and rotatably positioned upon the respective rotor blade shafts.

A number of embodiments of drive assemblies may provide for interconnection between the first rotor blade key and the first rotor blade motivator, and between the second rotor blade key and the second rotor blade motivator. A tongue and groove joint may provide for a groove component to mate with a tongue component and for drive rotation of the drive assembly to impart key rotation on the first and second rotor blade keys. Another embodiment of a drive assembly may incorporate rotor blade motivators with motivator gear teeth which mesh with rotor blade key teeth of the rotor blade keys and provide for drive rotation of the drive assembly to impart key rotation on the first and second rotor blade keys.

For a further preferred embodiment of the drive assembly, drive rotation of the respective drive assemblies imparts lateral key movement on respective blade keys. Lateral key movement of the blade keys may be facilitated by lateral key rollers riding upon lateral key tracks. The respective blade keys may be engaged by the respective drive assemblies through the interaction of the drive assembly teeth and the blade key teeth and the corresponding interaction between the blade key teeth and the rotor blade shaft teeth. Respective lateral key movement imparted by drive rotation imparts respective rotor blade key rotation which causes rotation of the respective tubular shaft which imparts respective blade pitch of the respective blade pitching section of the respective rotor blade.

For preferred embodiments of the drive assembly, the rotor blade motivators may be hydraulically powered or electrically powered, and may incorporate one or more hydraulic cylinders, one or more screw drives or other drive mechanism which will be known to persons of skill in the art in view of the disclosures of this specification and the drawings. Preferred embodiments of the drive assemblies and the rotor blade motivators for each rotor blade may be attached to and anchored by the rotor shaft of the opposing rotor blade, or may otherwise attached to and anchored by one or more components of the rotor sleeve. The first rotor blade motivator and the second rotor blade motivator may be electric motor driven, hydraulically driven, or a combination of electric and hydraulic drive.

The rotor blade motivators may incorporate a number of mechanisms that provide for the controllable pitching of the rotor blades in the blade extended configuration. A rotor blade controller may provide for interaction of a pilot of the VTOL aircraft with the rotor blade motivators. A blade control algorithm of the rotor blade controller may provide for varying levels of automation in the control of the rotor blade motivators, and the resultant pitch of the respective rotor blades and for the achievement of desired flight control of the VTOL aircraft based upon pilot interaction with the rotor blade controller and the resultant interaction of the rotor blade controller with the blade motivators.

The rotor blade controller may also provide for controlling the extension of the first rotor blade and the second rotor blade from the blade retracted configuration to the extended configuration and the retraction of the first rotor blade and the second rotor blade from the blade extended configuration to the rotor blade retracted configuration.

Pressurized air may be supplied by air supply lines to rotor air cylinders proximal to the blade ends through a pressurization passage in the rotor blade shafts. This results in a blade extension force being applied to the respective cylinder end walls of the respective rotor blades in respective rotor air cylinders as pressurized air is provided to the rotor air cylinders. For alternative preferred embodiments, pressurized air may be supplied to the rotor sleeve chamber of the rotor sleeve. Pressurized air may be introduced at the rotor hub by devices and mechanisms that will be obvious to persons of skill in the art, in view of the disclosures of this specification and the drawings. The introduction of pressurized air to the rotor sleeve chamber results in the application of a chamber blade extension force to the blade inside end surface of each of the respective rotor blades.

Further alternative embodiments may provide for the first rotor blade and the second rotor blade to be extended from the retracted configuration to the blade extended configuration through the use of centrifugal force by initiating rotor assembly rotation. Other embodiments of extension and retraction mechanisms may incorporate mechanical, electrical or hydraulic devices and mechanisms.

For a preferred embodiment, as the aircraft forward movement is commenced and air speed of the aircraft exceeds the stall speed of the primary wing of the aircraft, the first rotor blade and the second rotor blade may be retracted by slowing the rotor assembly rotation and allowing the axial wind force imposed on the first blade end as the first rotor blade is positioned into the wind, in the direction of motion of the aircraft, and the second rotor blade end as it is rotated into the direction of the travel of the aircraft. The first rotor blade and the second rotor blade may be retracted to the blade retracted configuration and may remain in the blade retracted configuration until the first rotor blade and the second rotor blade are returned to the blade extended configuration through the use of pressurized air, centrifugal force from increased rotation speed for the blade assembly, or other rotor blade extension mechanisms.

### BRIEF DESCRIPTION OF THE DRAWINGS

FIG. 1 is a side elevation view of a preferred embodiment of a rotor assembly of the present invention with rotor blades in a blade retracted configuration.

FIG. 2 is a plan view of a preferred embodiment of a rotor assembly of the present invention with rotor blades in a blade retracted configuration.

FIG. 3 is a side perspective view of a preferred embodiment of a rotor assembly of the present invention with rotor blades in a blade retracted configuration.

FIG. 4 is a plan view of a preferred embodiment of a rotor assembly of the present invention with rotor blades in a blade extended configuration.

FIG. 5 is a side elevation view of a preferred embodiment of a rotor assembly of the present invention with rotor blades in a blade extended configuration.

FIG. 6 is a side perspective view of a preferred embodiment of a rotor assembly of the present invention with rotor blades in a blade extended configuration.

FIG. 7 is a perspective plan view of a preferred embodiment of a rotor assembly of the present invention with rotor sleeve shell cut away, revealing a sleeve chamber and rotor blades in a blade retracted configuration.

FIG. 8 is a perspective plan view of a preferred embodiment of a rotor assembly of the present invention with rotor sleeve shell cut away, revealing a sleeve chamber and rotor blades in a blade extended configuration.

FIG. 9 is a perspective plan view detail of a preferred embodiment of a rotor assembly of the present invention showing an end of a rotor sleeve with rotor blades in a blade retracted configuration with rotor sleeve shell cutaway and rotor blade shell cutaway revealing preferred rotor sleeve and rotor blade structure, rotor blade pitching mechanism, and rotor blade extension mechanism options.

FIG. 10 is a perspective plan view detail of a preferred embodiment of a rotor assembly of the present invention showing an end of a rotor sleeve with rotor blades in a blade extended configuration with rotor sleeve shell cutaway and rotor blade shell cutaway revealing preferred rotor sleeve and rotor blade structure, rotor blade pitching mechanism, and rotor blade extension mechanism options.

FIG. 11 is an end elevation view of a preferred embodiment of a rotor assembly of the present invention with rotor blade in a blade extended configuration, illustrating rotor blade pitching as controlled by a blade motivator and rotor blade controller.

FIG. 12 is a plan view detail of a preferred embodiment of a rotor assembly of the present invention showing an end of a rotor sleeve and a rotor blade in a blade extended configuration with rotor sleeve shell cutaway revealing structure details of a preferred rotor sleeve and rotor blade structure and a preferred rotor blade pitching mechanism.

FIG. 13 is a cross section detail of a tongue and groove embodiment of a rotor blade pitching mechanism and drive assembly of a preferred embodiment of a rotor assembly of the present invention, with the pitching mechanism and drive assembly positioning the rotor blade in a neutral pitch position.

FIG. 14 is a cross section detail of a tongue and groove embodiment of a rotor blade pitching mechanism and drive assembly of a preferred embodiment of a rotor assembly of the present invention with the pitching mechanism and drive assembly engaged, with the rotor blade pitched to a positive pitch position.

FIG. 15 is a cross section detail of a gear meshing embodiment of a rotor blade pitching mechanism and drive assembly of a preferred embodiment of a rotor assembly of the present invention, with the pitching mechanism and drive assembly positioning the rotor blade in a neutral pitch position.

FIG. 16 is a cross section detail of a gear meshing embodiment of a rotor blade pitching mechanism and drive assembly of a preferred embodiment of a rotor assembly of the present invention with the pitching mechanism and drive assembly engaged, with the rotor blade pitched to a positive pitch position.

FIG. 17 a plan view perspective view detail of a geared lateral key embodiment of a rotor blade pitching and drive assembly of a preferred embodiment of a rotor assembly of the present invention.

FIG. 18 is a cross section detail of a geared lateral key embodiment of a rotor blade pitching mechanism and drive assembly of a preferred embodiment of a rotor assembly of the present invention.

FIG. 19 is a cross section detail of an embodiment of a geared lateral key and an interconnection of a geared rotor blade key and the geared lateral key of a lateral key embodiment of a rotor blade pitching mechanism and drive assembly of a preferred embodiment of a rotor assembly of the present invention.

FIG. 20 is a cross section detail of an interconnection of a geared rotor blade key and the geared lateral key of a lateral key embodiment of a rotor blade pitching mechanism and drive assembly of a preferred embodiment of a rotor assembly of the present invention.

FIG. 21 is a side perspective view detail of an example embodiment of a drive assembly and rotor blade motivator that is not attached to or anchored by the opposing rotor shaft and has a telescoping hydraulic motivator connected to a respective rotor blade key in a tongue and groove joint, the telescopic hydraulic motivator being retracted to a rotor blade neutral pitch position.

FIG. 22 is a side perspective view detail of an example embodiment of a drive assembly and rotor blade motivator that is not attached to or anchored by the opposing rotor shaft and has a telescoping hydraulic motivator connected to a respective rotor blade key in a tongue and groove joint, the telescopic hydraulic motivator extended to a rotor blade positive pitch position.

FIG. 23 is a side perspective cutaway view of a blade sleeve of a rotor sleeve of the present invention showing an optional sleeve spoiler affixed to the blade sleeve.

### DETAILED DESCRIPTION OF PREFERRED EMBODIMENTS

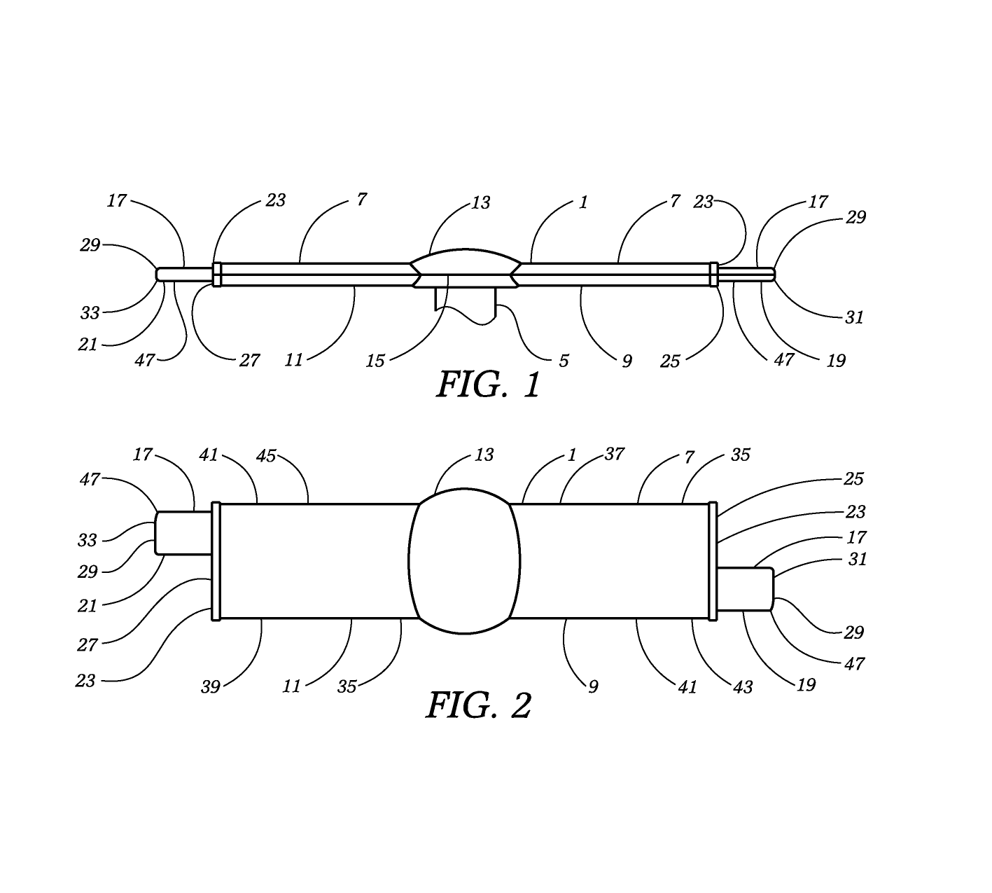

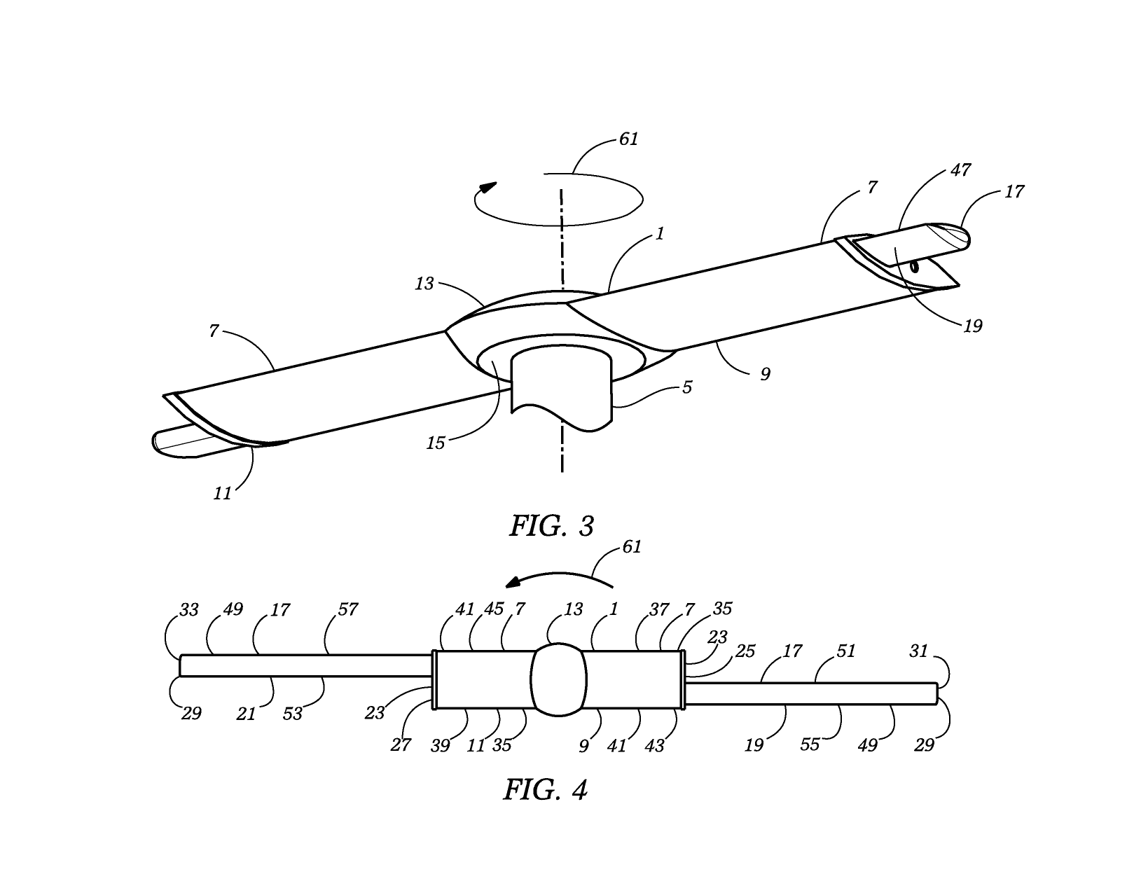

Referring first to FIG. 1, a side elevation view of a preferred embodiment of a VTOL rotor assembly 1 of the present invention the rotor blades 17, which include the first rotor blade 19 and the second rotor blade 21 in the blade retracted and stowed configuration 47, herein after referred to as the blade retracted configuration 47. For the embodiment shown, the rotor assembly 1 is connected to a rotor power assembly (not shown) by a rotor shaft 5. Referring now to FIG. 3, a side view perspective of the preferred embodiment of the rotor assembly 1 shown in FIG. 1, the connection plate 15 may provide for the reinforcement of the rotor hub 13 of the rotor assembly 1 and for the transfer of power from the rotor shaft 5 to the rotor assembly 1 at the rotor hub 13.

Referring further to FIG. 1 and FIG. 3, and also referring to FIG. 2, a plan view of the preferred embodiment of the rotor assembly 1 of the present invention shown in FIG. 1, a preferred embodiment of the rotor assembly 1 of the present invention has a rotor sleeve 7, which includes a first blade sleeve 9 and a second blade sleeve 11. The rotor sleeve 7 has blade sleeve ends 23, including a first blade sleeve end 25 and a second blade sleeve end 27. The rotor blades 17, having rotor blade ends 29, which include first rotor blade end 31 for the first rotor blade 19 and second rotor blade end 33 for the second rotor blade 21, the rotor blades 17 being shown in the blade retracted configuration 47 in FIGS. 1, 2, 3.

Referring further to FIG. 3, and also to FIG. 4, which shows the rotor assembly 1 in the blade extended configuration 49, for the purposes of the specifications and the drawings, the direction of rotor assembly rotation 61 shall be shown and described as counter-clock wise as viewed from above the rotor assembly 1. It should be noted that the direction of rotor rotation varies for helicopters and compound VTOL aircraft. For helicopters manufactured in the United States, the predominant direction of rotor rotation is clockwise when viewed from above the rotor, while the predominant direction of rotor rotation of helicopters manufactured outside the U.S. is counter-clockwise. However, there is no functional difference or limitation in providing for counter clockwise or clockwise rotor assembly rotation 61 for the present invention. Merely for ease of presentation, the drawings and related description for the preferred embodiments shown and described are presented with a counter-clockwise rotor assembly rotation 61.

Referring further to FIG. 2 and to FIG. 4, in consideration of the counter-clockwise direction of rotor assembly rotation 61, the rotor sleeve 7 has rotor sleeve leading edges 35, including first blade sleeve leading edge 37 and second blade sleeve leading edge 39. The rotor sleeve 7 also has rotor sleeve trailing edges 41, including a first blade sleeve trailing edge 43 and a second blade sleeve trailing edge 45.

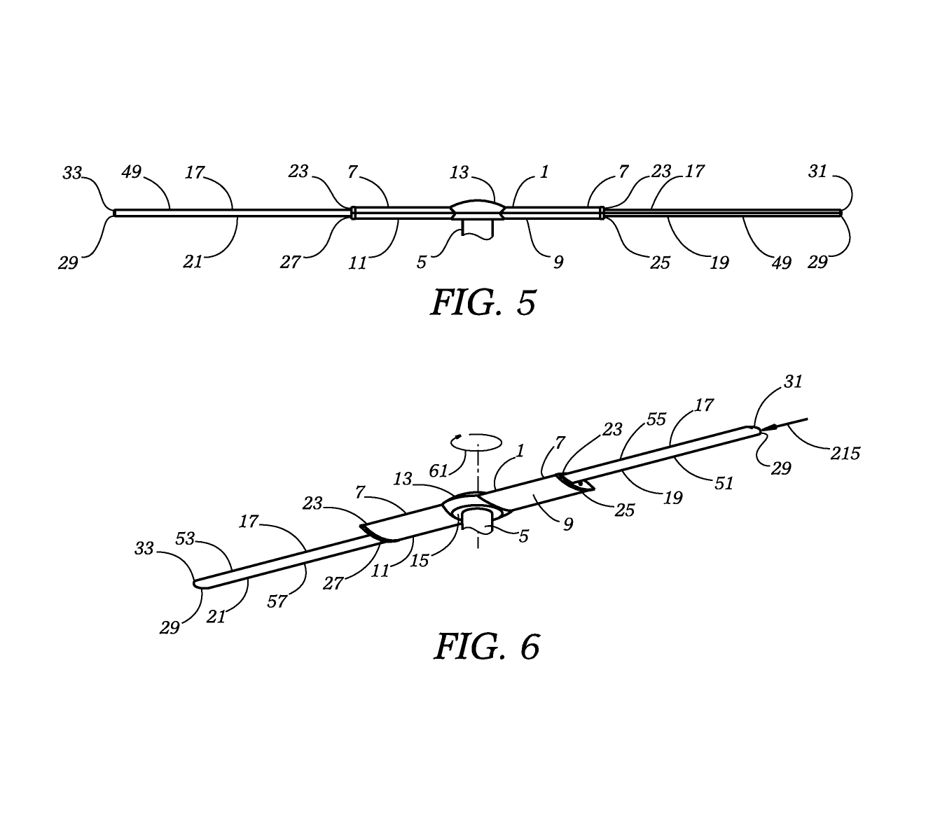

Referring further to FIG. 4, a plan view, and also to FIG. 5, a side view, and FIG. 6, a perspective side view, of a preferred embodiment of the rotor assembly 1 of the present invention, the rotor blades 17 are shown in a blade extended configuration 49. Again, in consideration of the rotor assembly direction 61, the first rotor blade 19 has a first blade leading edge 51 and a first blade trailing edge 55, and the second rotor blade 21 has a second blade leading edge 53 and a second blade trailing edge 57.

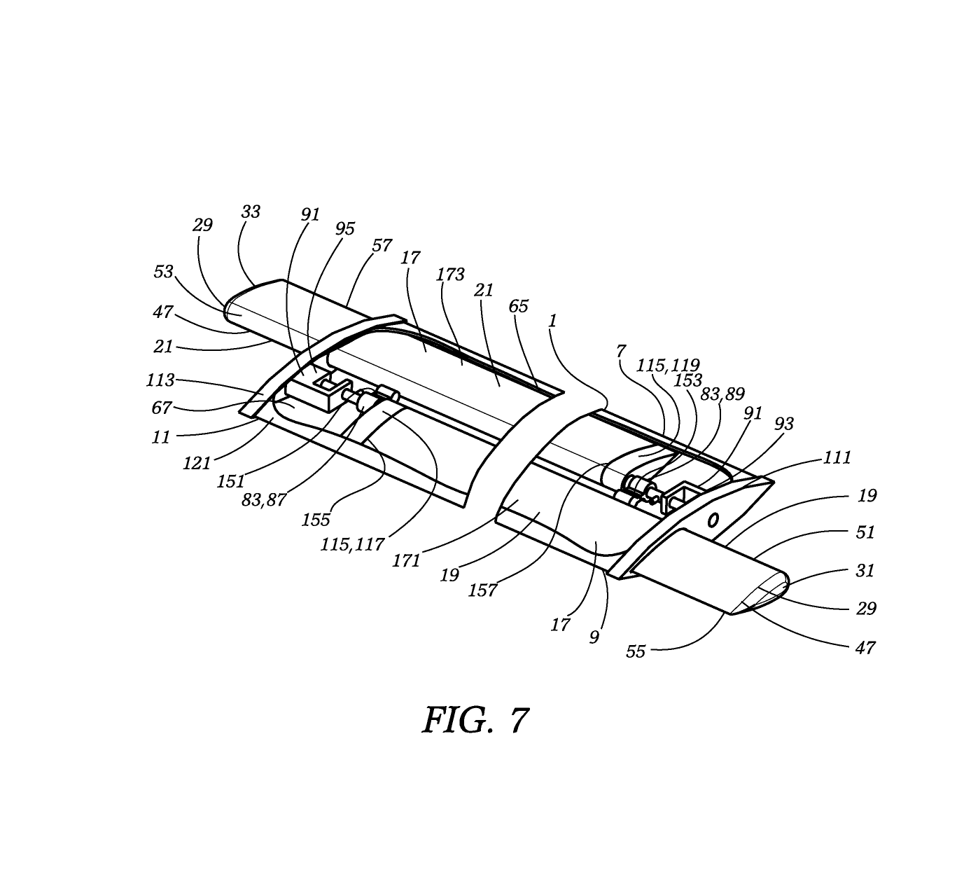

Referring now to FIG. 7, a perspective plan view of a preferred embodiment of the rotor assembly 1 of the present invention with the rotor sleeve shell 65 cut away of the rotor sleeve shell 121, revealing the sleeve chamber 67 and showing the rotor blades 17 in the retracted configuration 47. For the embodiment shown, each of the rotor blades 17 have a blade non-pitching section 115 and a blade drive key 83. First rotor blade 19 has a first blade non-pitching section 117 a position proximal to first rotor blade key 87 which is positioned proximal to a first blade inside end 151. Likewise the second rotor blade 21 has a second blade non-pitching section 119 which is positioned proximal to a second blade key 89 which is positioned proximal to second blade inside end 153. A first blade pitch joint 155 rotatably separates the first blade non-pitching section 117 from the first blade pitching section 171. A second blade pitch joint 157 rotatably separates the second blade non-pitching section 119 from the second blade pitching section 173.

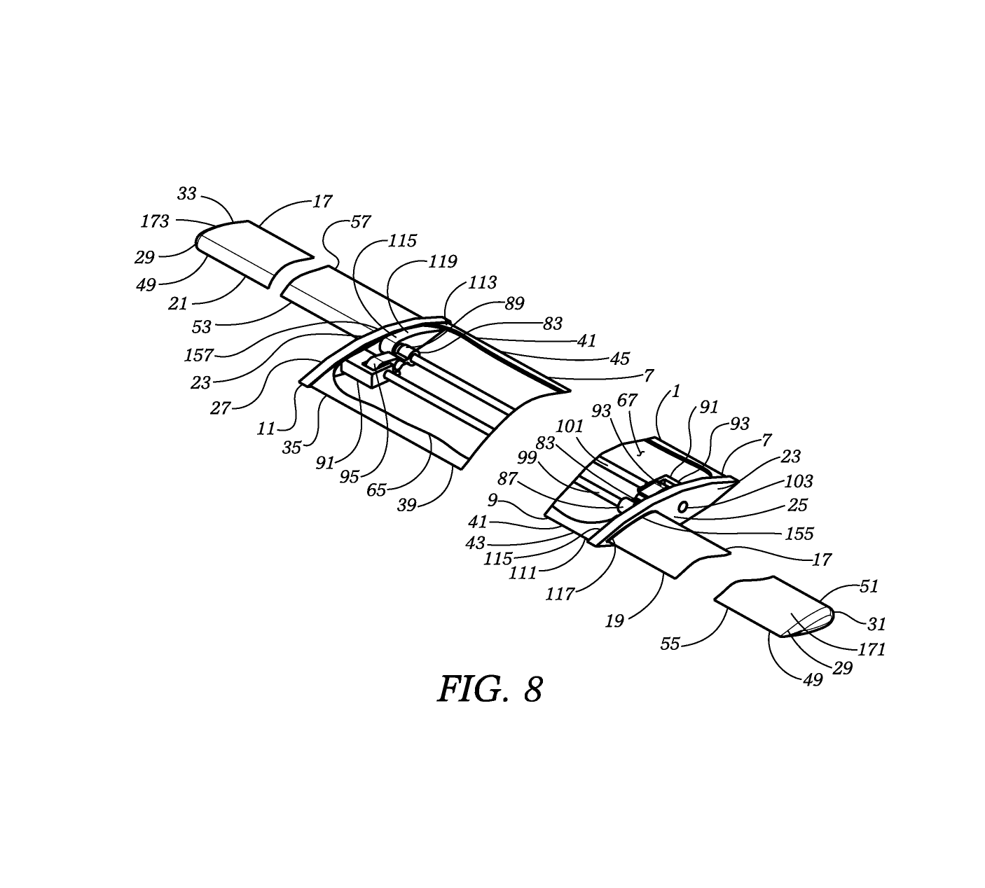

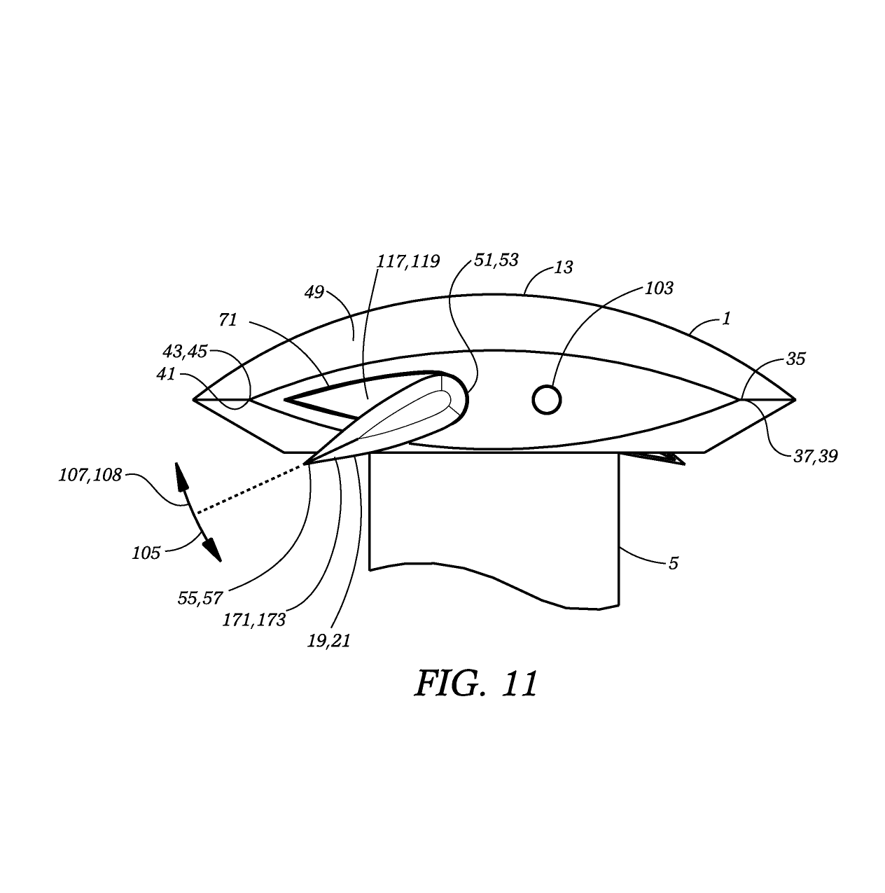

Referring now to FIG. 8, a perspective plan view of a preferred embodiment of the rotor assembly 1 of the present invention with the rotor sleeve shell 65 cut away, revealing the sleeve chamber 67 and showing the rotor blades 17 in a blade extended configuration 49. The first blade pitch joint 155 is positioned outside the first rotor blade sleeve end 25 and the second blade pitch joint 157 is positioned outside the second rotor blade sleeve end 27 which provide for first blade pitch 107 and second blade pitch 108, as shown in FIG. 11.

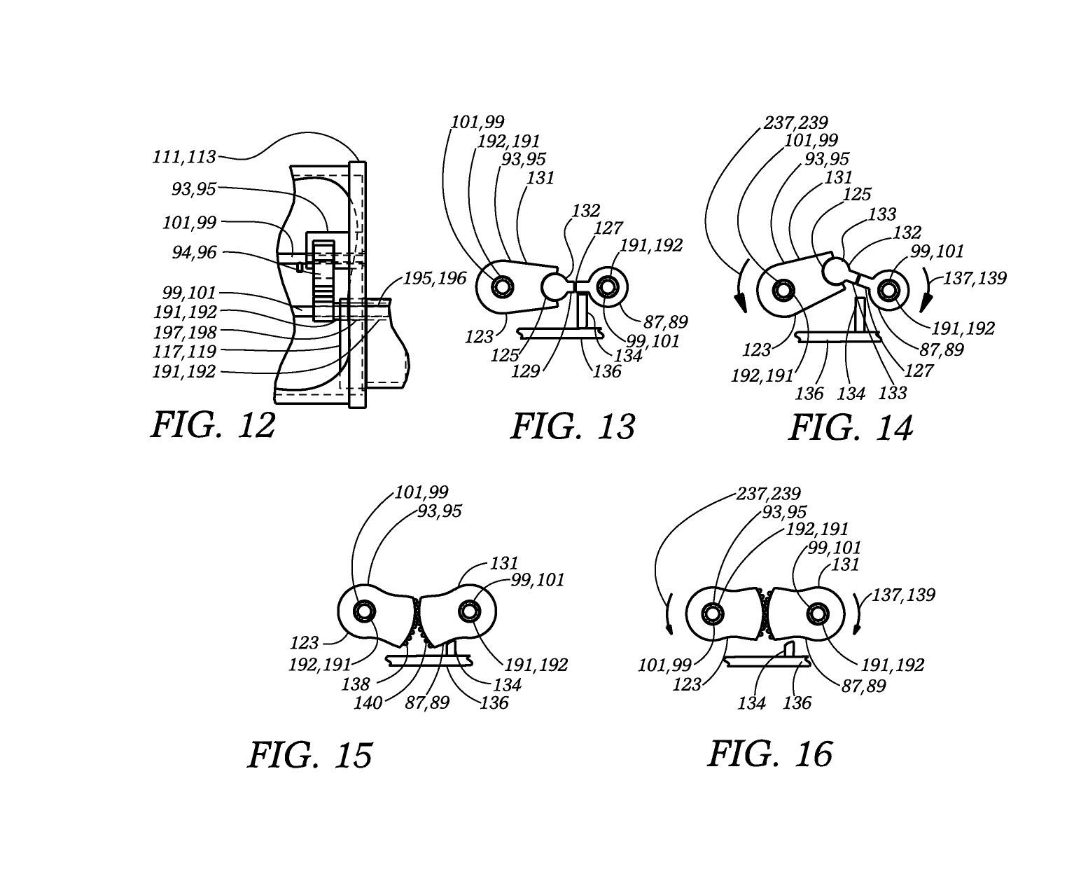

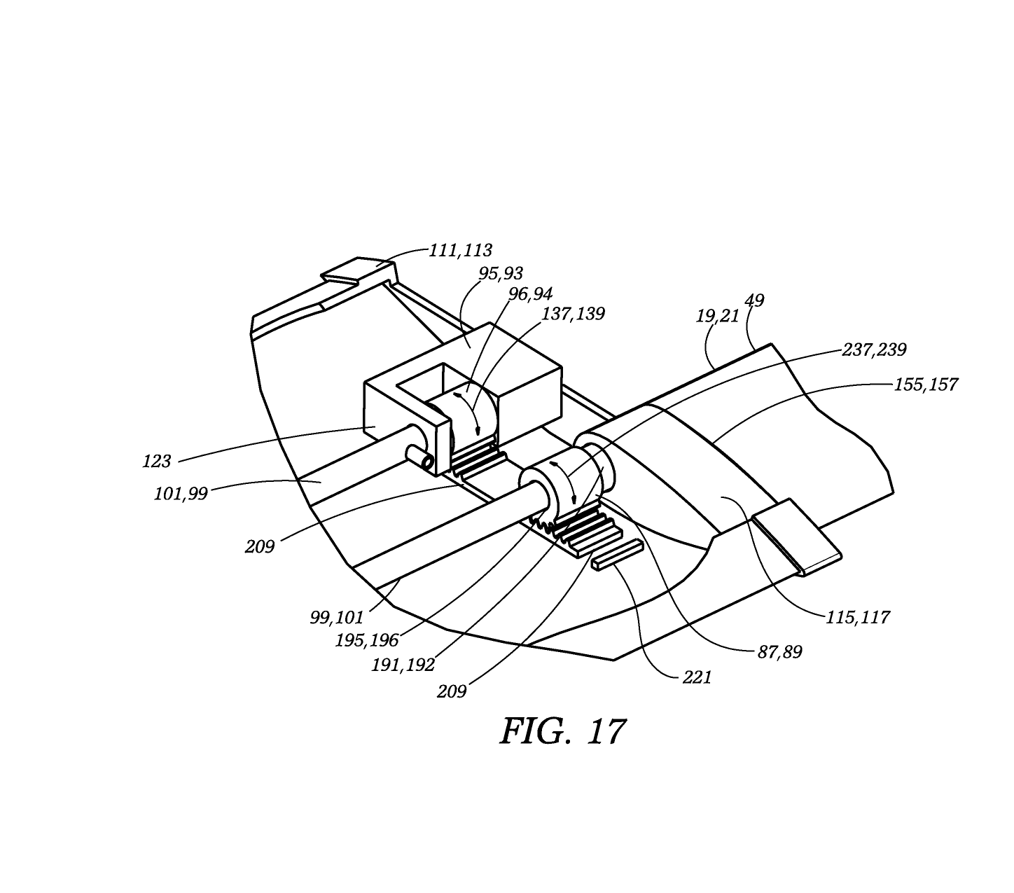

First blade pitch 107 may be controlled by first blade motivator 93 and second blade pitch 108 may be controlled by second motor blade motivator 95. The first blade motivator 93 may be connected to first blade pitching section 171 by first tubular shaft 191 and the second blade motivator 95 may be connected to the second blade pitching section 173 by second tubular shaft 192, as shown in FIG. 12. and FIG. 17. First rotor blade 19 and second rotor blade 21 are in the blade extended position configuration 49, and first blade key rotation 237 imparted on the first rotor blade key 87 by first blade motivator 93 through rotation of the first motivator driver 94 which causes the first tubular shaft 191 to rotate, which imparts first blade pitch 107 on the first blade pitching section 171 of first rotor blade 19. Likewise, second rotor blade key rotation 239 imparted on second rotor blade key 89 by second rotor blade motivator 95 through rotation of the second motivator driver 96 which causes the second tubular shaft 192 to rotate, which imparts second blade pitch 108 on the second blade pitching section 173 of the second rotor blade 21. A first shaft bearing 195 may provide for the first blade pitch 107 of the first tubular shaft 191 upon the first rotor blade shaft 99. Likewise, a second shaft bearing 196 may provide for second blade pitch 108 of second tubular shaft 192 upon second rotor blade shaft 101.

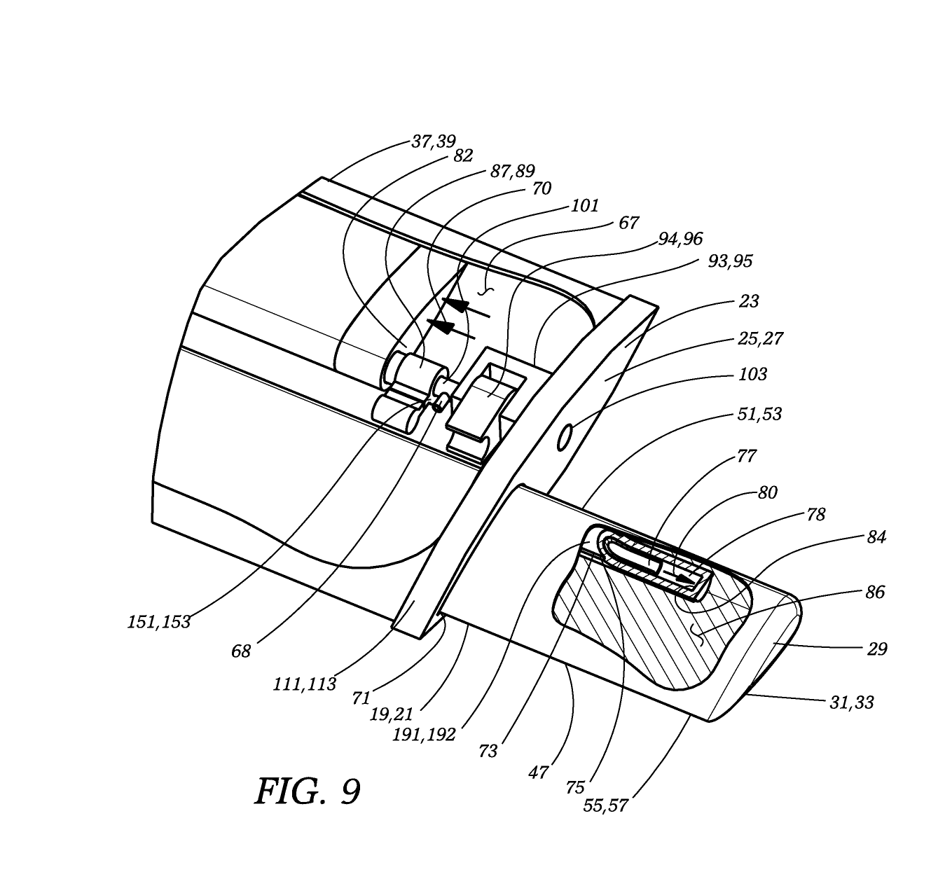

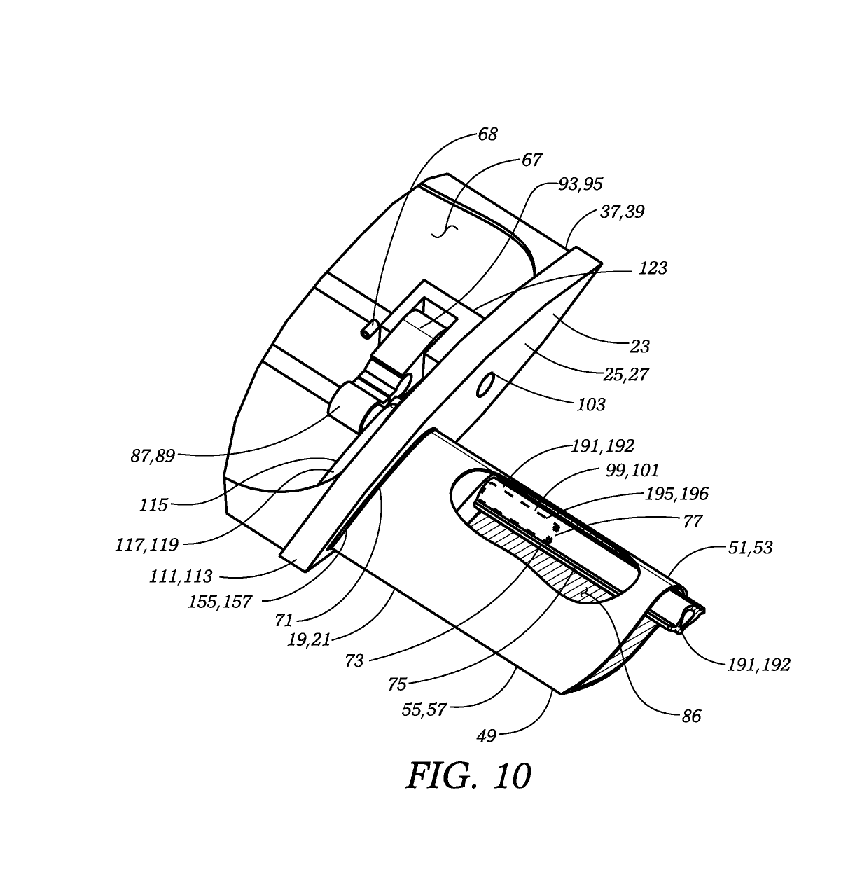

As shown in FIG. 9 and FIG. 10, the first rotor blade shaft 99 and the second rotor blade shaft 101 may be tubular, but may be solid for other embodiments. The first rotor blade shaft 99 and the second rotor blade shaft 101 may be non-rotating and may extend beyond the first blade sleeve end 25 and the second blade sleeve end 27 respectively, when the rotor blades 17 are in a blade retracted configuration 47, by approximately the distance that the first rotor blade 19 and the second rotor blade 21 respectively extend beyond the first blade sleeve end 25 and the second blade sleeve end 27 respectively, when the rotor blades 17 are in the blade retracted configuration 47.

Referring also to FIG. 9 and FIG. 10, the first rotor blade 19 may be extended through a sleeve end blade opening 71 from the retracted configuration 47 to the extended configuration 49 by the first tubular shaft 191 sliding upon first rotor blade shaft 99, and the second rotor blade 21 may be extended through a sleeve end blade opening 71 from the retracted configuration 47 to the extended configuration 49 by the second tubular shaft 192 sliding upon second rotor blade shaft 101. The first and second rotor blade shafts 99 and 101 may be secured in place by a blade sleeve shaft anchor 103 in the respective first and second rotor blade sleeve ends 25, 27. First rotor blade sleeve end 25 may have a first rotor blade sleeve end cap 111 and second rotor blade sleeve end 27 may have a second rotor blade sleeve end cap 113.

Referring further to FIG. 12, the first shaft bearing 195 and the second shaft bearing 196 respectively may consist merely of the slidable and rotatable contact of all or a portion of the inside surface of the respective first tubular shaft 191 and the second tubular shaft 192 with the outside surface of the respective first and second rotor blade shafts 99, 101, which may be lubricated as needed, or one or more mechanical bearings known to persons of skill in the art, in view of the disclosures of this specification and the drawings, may be provided.

Referring further to FIG. 12 and FIG. 10, a first pass bearing 197 may provide for the rotation of first tubular shaft 191 in the first non rotating section 117, and a second pass bearing 198 may provide for the rotation of the second tubular shaft 192 in the second non-rotating section 119. Each of the tubular shafts 191, 192 may have a blade rib 73 positioned in a blade rib track 75 in the blade core 86. The tubular shafts 191, 192, the blade rib 75, and the blade core 86 may provide for reinforcing, strengthening and stiffening of each of the rotor blades 19, 21, along with the rotor blade shell 88. The blade core 86, which may be comprised of a lightweight structural foam or other material known to persons of ordinary skill in the art, in view of the disclosures of this specification and the drawings, may also assist in maintaining the proper alignment and positioning of the tubular shafts 191, 192 in the respective rotor blades 19, 21. The rotor blade shell 88 may be comprised of various materials known to persons of ordinary skill in the art, in view of the disclosures of this specification and the drawings. The respective tubular shafts 191, 192 of the respective rotor blades 19, 21 may be slidably and rotatably positioned upon the respective rotor blade shafts 99, 101.

Referring now to FIG. 13 and FIG. 14, an illustration of an embodiment of an interconnection by a drive assembly 123 between the first rotor blade key 87 and the first rotor blade motivator 93, and between the second rotor blade key 89 and the second rotor blade motivator 95 respectively, is shown. In the tongue and groove joint 125, the groove component 131 may mate with tongue component 132 and drive rotation 137, 139 of drive assembly 123 imparts key rotation 237, 239 on the respective first and second rotor blade keys 87, 89. A slip joint 127 may provide for the tongue component 132 to extend from the tongue retracted configuration 129 to tongue extended configuration 133 as shown in FIG. 13 and FIG. 14 respectively, and for retraction of the tongue component 132 to the tongue retracted configuration 129. A motivator drive stop 134, which may be attached to the sleeve base 136, may provide for positioning and support of groove component 131 for the ready insertion of the tongue component 132 as the respective rotor blade 19, 21 transitions from the blade retracted configuration 47 to the blade extended configuration 49, and for the ready retraction of the respective rotor blade 19, 21 from the blade extended configuration 49 to the rotor blade retracted configuration 47. The motivator drive stop 134 may also be used to prevent the respective rotor blade 19, 21 from pitching below the neutral position when the respective rotor blade 19, 21 is in the blade extended configuration 49, which would result is a downward thrust imparted on the VTOL aircraft.

Referring now to FIG. 15 and FIG. 16, another embodiment of a drive assembly 123 incorporating a first rotor blade motivator 93, and a second rotor blade motivator 95 respectively may provide for motivator rotation 137, 139 respectively to impart rotor blade key rotation 237, 239 by gear type meshing between motivator gear teeth 138 with rotor blade key teeth 140 as shown in FIG. 15 and FIG. 16.

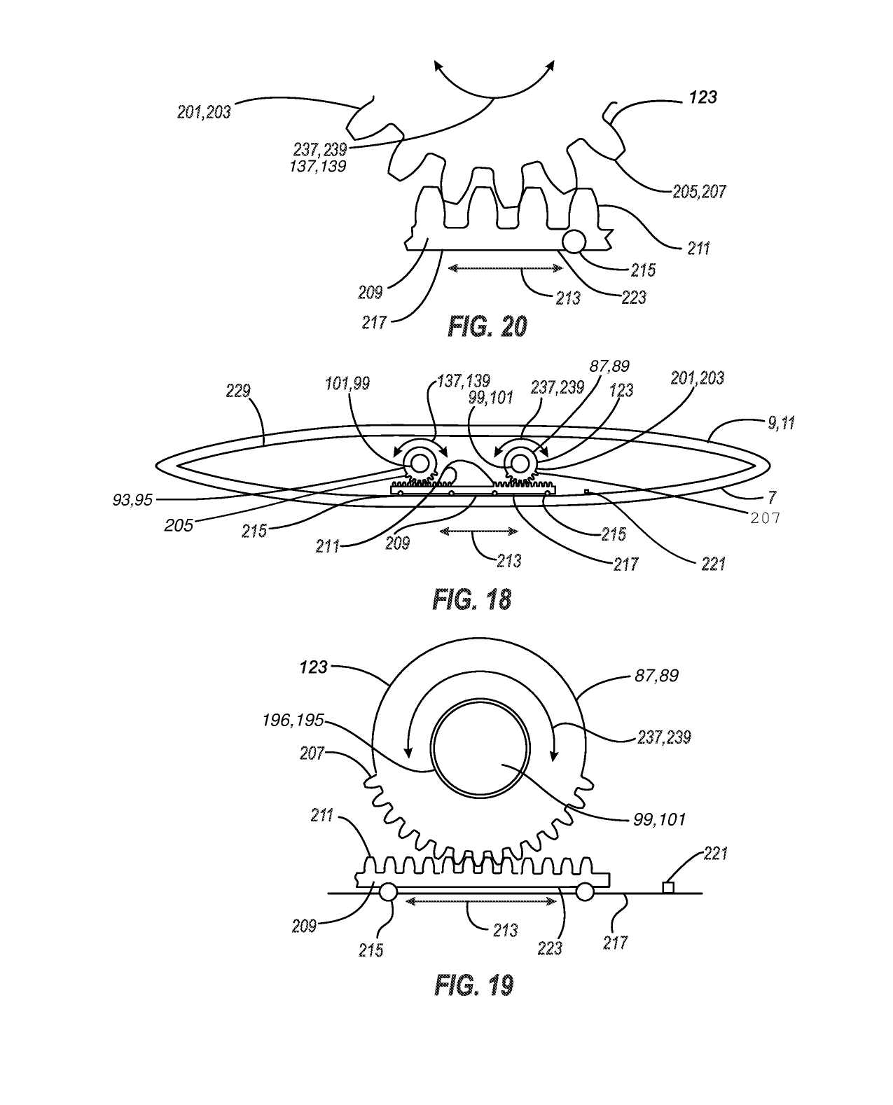

Referring now to FIGS. 17-18, a preferred alternative embodiment for the drive assembly 123 is shown. For this alternative, drive rotation 137, 139 of the respective rotor blade motivators 93, 95 by the respective drive assemblies 123 imparts lateral key movement 213 on the respective blade keys 209. Referring also to FIG. 19 and FIG. 20, lateral key movement 213 of the blade keys 209 may be facilitated by lateral key rollers 215 affixed to the lateral key base 223, the lateral key rollers 215 riding upon a lateral key track 217. The respective blade keys 209 may be engaged by the respective drive assemblies 123 through the interaction of the drive assembly teeth 205 and the blade key teeth 211 and the corresponding interaction between the blade key teeth 211 and the rotor blade shaft teeth 207. Respective lateral key movement 213 imparted by drive rotation 137, 139 imparts respective rotor blade key rotation 237, 239 which causes rotation of the respective tubular shaft 191, 192, which imparts respective blade pitch 107, 108 of the respective blade pitching section 171, 172 as shown in FIG. 11. A lateral key stop 221 may also be used to prevent the respective rotor blade 19, 21 from pitching above the neutral position when the respective rotor blade 19, 21 is in the blade extended configuration 49, which would result is a downward thrust imparted on the VTOL aircraft.

For the preferred embodiments of the drive assembly 123 of FIGS. 7-20, the rotor blade motivators 91 may be hydraulically powered or electrically powered, and may incorporate one or more hydraulic cylinders, one or more screw drives or other drive mechanism which will be known to persons of skill in the art in view of the disclosures of this specification and the drawings. Further, although the embodiments of the drive assemblies 123 and the rotor blade motivators 91 for each rotor blade 19, 21 illustrated in the figures are attached to and anchored by the rotor shaft 99, 101 of the opposing rotor blade 21, 19, other embodiments of the drive assemblies 123 and the rotor blade motivators 91 which are not attached to or anchored by the rotor shaft 99, 101 of the opposing rotor blade 21, 19, but which are otherwise attached to and anchored by one or more components of the rotor sleeve 7, will be obvious to persons of skill in the art, in view of the disclosures of this specification and the drawings.

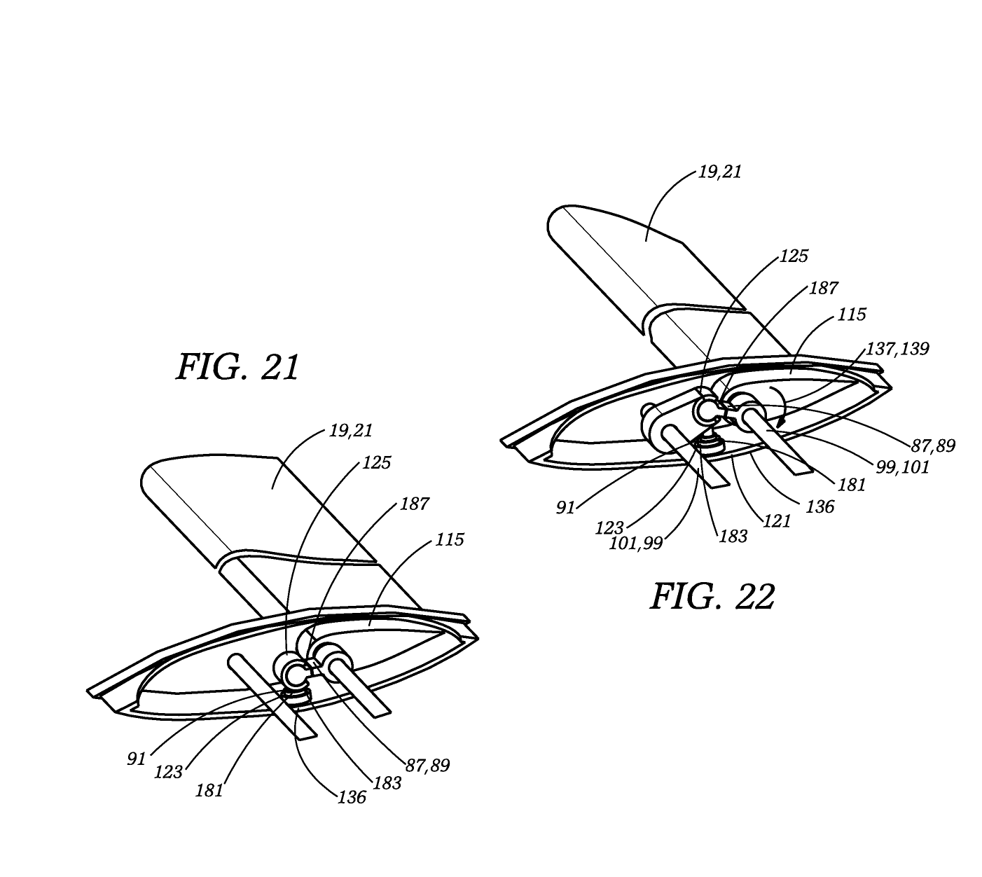

An example embodiment of a drive assembly 123 and rotor blade motivator 91 that is not attached to or anchored by the opposing rotor shaft 101, 99 is illustrated in FIGS. 21-22. For this illustration, a telescoping hydraulic motivator 181 is connected to a respective rotor blade key 87, 89 in a tongue and groove joint 125. For this example, the rotor blade key 87, 89 is a telescopic blade key 187. As the hydraulic motivator 181 extends from the motivator retracted configuration 183 shown in FIG. 21, to the motivator extended configuration 185 shown in FIG. 22. Extension of the hydraulic motivator 181 imparts respective rotor blade key rotation 237, 239 on the rotor blade key 87, 89 which causes rotation of the respective tubular shaft 191, 192, which imparts respective blade pitch 107, 108 of the respective blade pitching section 171, 172.

It should be noted that the illustrations of interconnections between the first rotor blade motivator 93 and the first rotor blade 19 and between the second rotor blade motivator 95 and the second rotor blade 21, such as the drive assemblies 123 shown in FIGS. 10, 12-20 are mere illustrations, and other variations of the interconnections between the first rotor blade motivator 93 and the first rotor blade 19, and between the second rotor blade motivator 95 and the second rotor blade 21 will be obvious to persons skilled in the art in view of the disclosures made in the drawings and this specification. The first rotor blade motivator 93 and the second rotor blade motivator 95 may be electric motor driven, hydraulically driven, or a combination of electric and hydraulic drive.

It should be further noted that the rotor blade motivators 91, namely the first rotor blade motivator 93 and the second rotor blade motivator 95 shown in the drawings, are mere illustrations of the rotor blade pitching mechanisms and devices that may be incorporated in the rotor assembly 1 of the present invention for the controllable pitching of the rotor blades 17, namely first blade pitch 107 and second blade pitch 108, with the rotor blades 17 in the blade extended configuration 49. A rotor blade controller may provide for interaction of a pilot of the VTOL aircraft with the rotor blade motivators 91. A blade control algorithm of the rotor blade controller may provide for varying levels of automation in the control of the rotor blade motivators 91, and the resultant pitch of the respective rotor blades 19, 21 and for the achievement of desired flight control of the VTOL aircraft based upon pilot interaction with the rotor blade controller and the resultant interaction of the rotor blade controller with the blade motivators 91.

The rotor blade controller may also provide for controlling the extension of the first rotor blade 19 and the second rotor blade 21 respectively from the blade retracted configuration 47 to the extended configuration 49 and the retraction of the first rotor blade 19 and the second rotor blade 21 from the blade extended configuration 49 to the rotor blade retracted configuration 47. Referring again to FIG. 9, pressurized air may be provided to the rotor air cylinders 78 through a pressurization passage 77 in the rotor blade shafts 99, 101. For such embodiments, pressurized air may be supplied to the pressurization passage 77 by air supply lines 68 connected to the rotor blade shafts 99, 101 as shown in FIG. 9 and FIG. 10. This results in a blade extension force 80 being applied to the respective cylinder end walls 84 of the respective rotor blades 19, 21 in respective rotor air cylinders 78 as pressurized air is provided to the rotor air cylinders 78. The air supply lines 68 may be connected to a pressurized air source at the rotor hub 13 by devices and mechanisms that will be obvious to persons of skill in the art, in view of the disclosures of this specification and the drawings.

For alternative preferred embodiments, pressurized air may be supplied to the rotor sleeve chamber 67 of the rotor sleeve 7. Pressurized air may be introduced at the rotor hub 13 by devices and mechanisms that will be obvious to persons of skill in the art, in view of the disclosures of this specification and the drawings. The introduction of pressurized air to the rotor sleeve chamber 67 results in the application of a chamber blade extension force 70 to the blade inside end surface 82 of each of the respective rotor blades 19, 21 as shown in FIG. 9.

Alternative embodiments for supplying pressurized air to the rotor blade shafts 99, 101 or the rotor sleeve chamber 67 may incorporate devices and mechanisms that will be obvious to persons of skill in the art, in view of the disclosures of this specification and the drawings.

Further alternative embodiments may provide for the first rotor blade 19 and the second rotor blade 21 to be extended from the retracted configuration 47 to the blade extended configuration 49 through the use of centrifugal force by initiating rotor assembly rotation 61.

Further alternative embodiments may provide for the first rotor blade 19 and the second rotor blade 21 to be extended from the retracted configuration 47 to the blade extended configuration 49, and retracted from the extended configuration 49 to the retracted configuration 47 by rotor blade extension mechanisms incorporating mechanical, electrical or hydraulic devices and mechanisms that will be obvious to persons of skill in the art, in view of the disclosures of this specification and the drawings.

Referring again to FIG. 6, for a preferred embodiment, as the aircraft forward movement is commenced and air speed of the aircraft exceeds the stall speed of the primary wing of the aircraft, the first rotor blade 19 and the second rotor blade 21 may be retracted by slowing the rotor assembly rotation 61 and allowing the axial wind force 215 imposed on the first blade end 31 as the first rotor blade 19 is positioned into the wind, in the direction of motion of the aircraft, and the second rotor blade end 33 as it is rotated into the direction of the travel of the aircraft. Therefore, the first rotor blade 19 and the second rotor blade 21 will be retracted to the blade retracted configuration 47 and will remain in the blade retracted configuration 47 until such time as the first rotor blade 19 and the second rotor blade 21 are returned to the blade extended configuration 49 through the use of pressurized air, centrifugal force from increased rotation speed for the rotor assembly rotation 61 for the blade assembly 1, or other rotor blade extension mechanisms.

Referring now to FIG. 11, the rotor blade controller may also be used to vary blade pitch position 105, including the first blade pitch 107 of the first blade pitching section 171 and the second blade pitch 108 of the second blade pitching section 173 respectively.

Other mechanisms and devices for the controllable extension and retraction of the first rotor blade 19 and the second rotor blade 21 and for controlling the first blade pitch 107 and the second blade pitch 108 of the rotor blades 19, 21 respectively will be known to persons of skill in the art in view of the disclosures of the drawings and the specification.

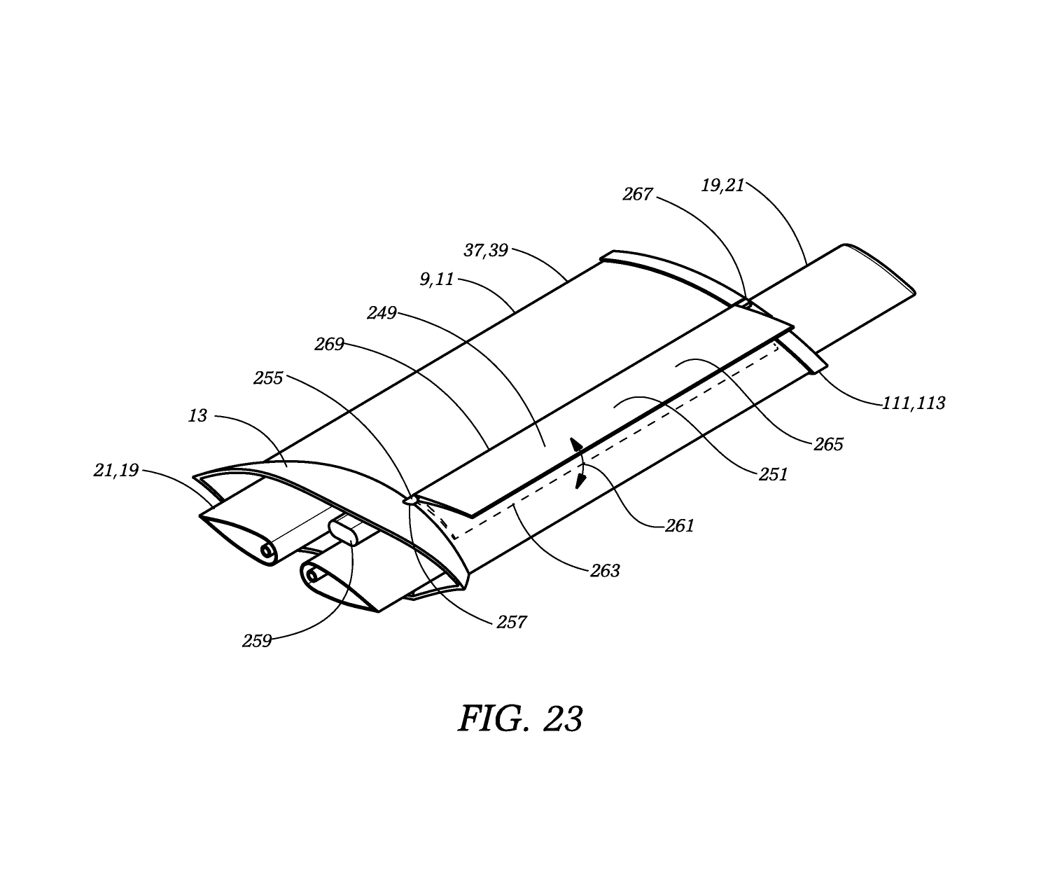

Referring now to FIG. 23, an embodiment of an optional sleeve spoiler assembly 249 incorporating a sleeve spoiler 251 is shown. Depending on the pitch of the blade sleeves 9, 11 with respect to the velocity of the VTOL aircraft with respect to the air that it is moving through, it may be desirable to reduce or eliminate any lift being generated by the blade sleeves 9, 11. A preferred mechanism for accomplishing this is a sleeve spoiler assembly 249 with a sleeve spoiler 251 positioned on each of the blade sleeves 9, 11. For the preferred embodiment shown, the spoiler pitch 261 of the sleeve spoiler 251 from a spoiler stowed position 263 to a spoiler active position 265 may be motivated by a spoiler actuator 259 positioned in the rotor hub 13 the sleeve spoiler 251 which may provide for the spoiler pitch 261 by rotating a spoiler shaft 255. The spoiler shaft 255 may extend from the spoiler actuator 259 through a spoiler shaft portal 257 in the rotor hub 13, through the sleeve spoiler 251 near the spoiler leading edge 269, to a spoiler end bearing 267 which may be affixed to the rotor blade sleeve end cap 111, 113 of the blade sleeve 9, 11. The sleeve spoiler 251 may be attached to the top or bottom, or both, of the blade sleeve 9, 11 in a manner such as that illustrated in FIG. 23. The sleeve spoiler 251 may also be attached to the top or bottom, or both, of the blade sleeve 9, 11 in a position closer to the blade sleeve leading edge 37, 39. The rotor blade controller may also control the spoiler actuator 259, which may be electronically or hydraulically motivated. Other embodiments and variations of the sleeve spoiler assembly 249 will be obvious to persons of skill in the art, in view of the disclosures of this specification and the drawings.

In view of the disclosures of this specification and the drawings, other embodiments and other variations and modifications of the embodiments described above will be obvious to a person skilled in the art. Therefore, the foregoing is intended to be merely illustrative of the invention and the invention is limited only by the following claims and the doctrine of equivalents.

What is claimed is:

1. A VTOL rotor assembly for a compound VTOL aircraft, the VTOL rotor assembly comprising:
a rotor sleeve comprising a first blade sleeve and a second blade sleeve;
a pair of rotor blades comprising a first rotor blade and a second rotor blade, the first rotor blade slidably anchored in the first blade sleeve and the second rotor blade slidably anchored in the second blade sleeve, the first rotor blade having a first blade pitching section and the second rotor blade having a second blade pitching section;
a blade extension and retraction capability comprising a first blade extension capability for a first extension of the first blade pitching section from the first blade sleeve from a first blade retracted configuration to a first blade extended configuration and a second blade extension capability for a second extension of the second blade pitching section from the second blade sleeve from a second blade retracted configuration to a second blade extended configuration, and further comprising a first blade retraction capability for a first retraction of the first blade pitching section in the first blade sleeve from the first blade extended configuration to the first blade retracted configuration and a second blade retraction capability for a second retraction of the second blade pitching section in the second blade sleeve from the second blade extended configuration to the second blade retracted configuration;
a first rotor blade pitching capability for controlling and motivating a first pitch of the first blade pitching section with the first rotor blade in the first blade extended configuration, and a second rotor blade pitching capability for controlling and motivating a second pitch of the second blade pitching section with the second rotor blade in the second blade extended configuration;
a rotor hub for connecting the rotor sleeve to a rotor shaft of a rotor power assembly.

2. A VTOL rotor assembly for a compound VTOL aircraft as recited in claim 1 wherein the first blade pitching capability comprises a drive assembly and a first rotor blade motivator, and the second blade pitching capability comprises a drive assembly and a second rotor blade motivator.

3. A VTOL rotor assembly for a compound VTOL aircraft as recited in claim 1 wherein the first rotor blade has a first rotor blade shaft with a first pressurization passage, the second rotor blade has a second rotor blade shaft with a second pressurization passage, the first blade extension capability includes a first pressurized air supply to the first pressurization passage, the second blade extension capability includes a second pressurized air supply to the second pressurization passage, the first rotor blade has a first rotor air cylinder with a first cylinder end wall proximal to the first blade end, the second rotor blade has a second rotor air cylinder with a second cylinder end wall proximal to the second blade end, the first pressurized passage being hydraulically connected to the first rotor air cylinder, the second pressurized passage being hydraulically connected to the second rotor air cylinder, providing for a blade extension force to be applied to the respective cylinder end walls of the respective rotor blades in respective rotor air cylinders as pressurized air is supplied to the rotor air cylinders.

4. A VTOL rotor assembly for a compound VTOL aircraft as recited in claim 1 wherein the first rotor sleeve has a first rotor sleeve chamber with a first blade inside end surface and the second rotor sleeve has a second rotor sleeve chamber with a second blade inside end surface, and wherein the first blade extension mechanism incorporates a first pressurized air supply hydraulically connected to the first rotor sleeve chamber and a second pressurized air supply hydraulically connected to the second rotor sleeve chamber, providing for pressurized air to be supplied to the first rotor sleeve chamber and the second rotor sleeve chamber respectively of the rotor sleeve, providing for the application of a chamber blade extension force to the first blade inside end surface and the second blade inside end surface.

5. A VTOL rotor assembly for a compound VTOL aircraft as recited in claim 1 wherein the wherein each drive assembly incorporates a tongue and grove motivator.

6. A VTOL rotor assembly for a compound VTOL aircraft as recited in claim 1 wherein the wherein each drive assembly incorporates a meshing gear motivator.

7. A VTOL rotor assembly for a compound VTOL aircraft as recited in claim 1 wherein the wherein each drive assembly incorporates a geared lateral key motivator.

8. A VTOL rotor assembly for a compound VTOL aircraft as recited in claim 1 further comprising a sleeve spoiler assembly.

9. A VTOL rotor assembly for a compound VTOL aircraft, the VTOL rotor assembly comprising:
a rotor sleeve comprising a first blade sleeve and a second blade sleeve;
a pair of rotor blades comprising a first rotor blade and a second rotor blade, the first rotor blade slidably anchored in the first blade sleeve and the second rotor blade slidably anchored in the second blade sleeve, the first rotor blade having a first blade pitching section and the second rotor blade having a second blade pitching section;
a first blade extension mechanism providing for a first extension of the first blade pitching section from the first blade sleeve from a first blade retracted configuration to a first blade extended configuration;
a second blade extension mechanism providing for a second extension of the second blade pitching section from the second blade sleeve from a second blade retracted configuration to a second blade extended configuration;
a first blade retraction mechanism providing for a first retraction of the first blade pitching section in the first blade sleeve from the first blade extended configuration to the first blade retracted configuration;
a second blade retraction mechanism providing for a second retraction of the second blade pitching section in the second blade sleeve from the second blade extended configuration to the second blade retracted configuration;
a first rotor blade pitching mechanism for controlling and motivating a first pitch of the first blade pitching section with the first rotor blade in the first blade extended configuration;
a second rotor blade pitching mechanism for controlling and motivating a second pitch of the second blade pitching section with the second rotor blade in the second blade extended configuration; and
a rotor hub for connecting the rotor sleeve to a rotor shaft of a rotor power assembly.

10. A VTOL rotor assembly for a compound VTOL aircraft as recited in claim 9 wherein the first blade pitching mechanism comprises a drive assembly and a first rotor blade motivator, and the second blade pitching mechanism comprises a drive assembly and a second rotor blade motivator.

11. A VTOL rotor assembly for a compound VTOL aircraft as recited in claim 9 wherein the first rotor blade has a first rotor blade shaft with a first pressurization passage, the second rotor blade has a second rotor blade shaft with a second pressurization passage, the first blade extension capability includes a first pressurized air supply to the first pressurization passage, the second blade extension capability includes a second pressurized air supply to the second pressurization passage, the first rotor blade has a first rotor air cylinder with a first cylinder end wall proximal to the first blade end, the second rotor blade has a second rotor air cylinder with a second cylinder end wall proximal to the second blade end, the first pressurized passage being hydraulically connected to the first rotor air cylinder, the second pressurized passage being hydraulically connected to the second rotor air cylinder, providing for a blade extension force to be applied to the respective cylinder end walls of the respective rotor blades in respective rotor air cylinders as pressurized air is supplied to the rotor air cylinders.

12. A VTOL rotor assembly for a compound VTOL aircraft as recited in claim 9 wherein the first rotor sleeve has a first rotor sleeve chamber with a first blade inside end surface and the second rotor sleeve has a second rotor sleeve chamber with a second blade inside end surface, and wherein the first blade extension mechanism incorporates a first pressurized air supply hydraulically connected to the first rotor sleeve chamber and a second pressurized air supply hydraulically connected to the second rotor sleeve chamber, providing for pressurized air to be supplied to the first rotor sleeve chamber and the second rotor sleeve chamber respectively of the rotor sleeve, providing for the application of a chamber blade extension force to the first blade inside end surface and the second blade inside end surface.

13. A VTOL rotor assembly for a compound VTOL aircraft as recited in claim 9 wherein the wherein each drive assembly incorporates a tongue and grove motivator.

14. A VTOL rotor assembly for a compound VTOL aircraft as recited in claim 9 wherein the wherein each drive assembly incorporates a meshing gear motivator.

15. A VTOL rotor assembly for a compound VTOL aircraft as recited in claim 9 wherein the wherein each drive assembly incorporates a geared lateral key motivator.

16. A VTOL rotor assembly for a compound VTOL aircraft as recited in claim 9 further comprising a sleeve spoiler assembly.
